(19) United States
(12) Patent Application Publication
(10) Pub. No.: US 2012/0223044 A1
(43) Pub. Date: Sep. 6, 2012

(54) Decorative Top for Bottle with Existing Lid

(75) Inventors: Leon James Scott, III, Atlanta, GA (US); Jonas McCracken, Atlanta, GA (US)

(73) Assignee: In Zone Brands, Inc., Smyrna, GA (US)

(21) Appl. No.: 13/410,946

(22) Filed: Mar. 2, 2012

Related U.S. Application Data
(60) Provisional application No. 61/449,318, filed on Mar. 4, 2011.

(51) Int. Cl. B65D 41/01; B23P 11/02; B65D 1/02; B65D 45/30; B65D 41/34; B65D 51/24

(52) U.S. Cl. 215/44; 215/274; 215/228; 215/329; 29/456; 29/453

(57) ABSTRACT

A bottle is assembled with an existing cap on its threaded neck to seal the contents in the bottle. A decorative top fits onto the existing cap and bottle for holding a decorative body, such as a figurine or the like, on a stem of the top. To open the bottle and use the decorative top, a removable rim comes off the top allowing it to be removed from the existing cap. The cap then twists off the bottle's neck and can be discarded. To reseal the bottle and allow drinking of its contents, the top with the removable rim detached threads onto the bottle's neck. A spout or valve of the top's stem can then be opened so contents of the bottle can be drunk from the stem.

### CROSS-REFERENCE TO RELATED APPLICATION

This application claims the benefit of U.S. Provisional Appl. No. 61/449,318, filed 4 Mar. 2011, which is incorporated herein by reference in its entirety.

### FIELD OF THE DISCLOSURE

The subject matter of the present disclosure relates generally to a container for dispensing liquid and, more particularly to, a beverage bottle top having a forecap arrangement for use on a lid of a bottle.

### BACKGROUND

Decorative bottle tops enhance beverage bottles for children. As illustrated in FIG. 1, for example, a decorative bottle 20 according to the prior art illustrated in FIG. 1 includes a cap 22, a stem 24, a spout or valve 30, and a decorative body 40. The cap 22 threads onto a beverage bottle 10 and can be removed so that the bottle 10 and cap 22 can be cleaned and reused. Portions of the top 20 are also shown in various views in FIGS. 2A-2C, and a top view of the bottle 10 is shown in FIG. 2D.

As best shown in FIGS. 2A-2B, the cap 22 has internal thread 23 for threading onto the neck of the bottle 10. The stem 24 extends from the cap 22 and defines an internal passage 28 that conveys liquid from the bottle 10. The spout or valve 30 on the end of the stem 24 permits or restricts the liquid from leaving the passage 28. The spout 30, which fits on the distal end of the stem 24, can be shifted up or down thereon or can have a diaphragm for allowing fluid to pass out of the spout 30. The stem 24 also includes keys or tabs 26 adjacent the cap 22 for holding a decorative body 40, such as a figurine.

For its part, the decorative body 40 defines a hollow 42 having first and second openings 44 and 46 for passage of the stem 24. To fixedly attach the body 40 to the cap 22, the body's first opening 44 engages the retaining tabs 26 on the stem 24. Meanwhile, the spout 30 extends beyond the second opening 24, enabling a person to access the spout 30 for drinking.

To seal and assemble the top 20 on the bottle 10 as shown, the bottle 10 is filled with beverage, and a foil seal (12: FIG. 2D) attaches to the rim (14) of the bottle 12. The cap 22 is then preferably preassembled with the spout 30, and the assembled top 20 is threaded onto the bottle 10. At this point, the decorative body 40 can be attached to the top 20 as described above. Alternatively, the decorative body 40 may be attached to the top 20 before the top 20 is threaded on the bottle 10.

Due to the shape of the top 20 with its long stem 24 and flat cap 22, the top 20 can be cumbersome to thread onto the bottle 10. This makes assembly of the top 20 to the bottle 10 difficult so that conventional assembly cannot be used. Instead, the top 20 must be manually applied in most instances directly on the sealed bottle 10. As expected, this process can be time consuming and inaccurate.

To use the bottle 10, the top 20 is twisted off the bottle 10, and the foil seal (12: FIG. 2D) is removed. The top 20 is then threaded back on the bottle 10 so it can be used for drinking. For sanitary purposes, the foil seal 12 is typically adhered quite firmly to the bottle 10 and may be hard to remove. As a result, some of the foil seal 12 may be left on the bottle 10, compromising the fit and seal of the repositioned top 20 on the bottle 10. Additionally, the bottle 10 and top 20 can often be washed and reused so that leaving any foil seal 12 can be undesirable.

Moreover, the top 20 preferably has an internal crab seal 25 as shown in FIG. 2B on its inside surface. When the foil seal 12 has been removed and the top 20 is repositioned on the bottle 10, this crab seal 25 helps engage and seal against the bottle's rim (14: FIG. 2D). However, when the top 20 is initially installed on the bottle 10 while the foil seal 12 is still present, the top's seal 25 tends press against the foil seal 12. Therefore, the foil seal 12 as shown in FIG. 2D must be indented to define enough space and must be firm enough across the top of the bottle's rim 14 to avoid damage when the top 20 is first assembled on the bottle 10. This requires more robustness to the foil seal 19 and further complicates the assembly of the top 20 to the bottle 10.

Having the top 20 threaded onto the bottle 10 over the foil seal 19 can make the assembly susceptible to tampering, theft, and damage. For example, while the bottle 10 is stored on a shelf, the top 20 can be readily threaded off the bottle 10 and stolen, misplaced, damaged, or the like. This may be the case even if a plastic shrink wrap is used around the outside of the top 20 and bottle 10. When the top 20 is removed, the bottle 10 is left on the shelf with only the foil seal 12 in place so that the bottle 10 cannot be sold. Moreover, having only the foil seal 12 over the contents makes the bottle 10 prone to damage and tampering.

Bottle tops having a fixed, decorative body such as discussed above provide an effective way to enhance a beverage bottle. However, manufacturers are continually striving to improve or enhance products. For this reason, the subject matter of the present disclosure is directed to overcoming, or at least reducing the effects of, one or more of the problems set forth above.

### SUMMARY

A bottle is assembled with an existing lid on its threaded neck to seal the contents in the bottle. A decorative forecap or top fits onto the existing lid and bottle for holding a decorative body, such as a figurine or the like, on a stem of the top. To open the bottle and use the decorative top, a removable strip on the top's rim can be removed, allowing the top to be removed from the existing lid. The lid then twists off the bottle's neck and can be discarded. To reseal the bottle and allow drinking of its contents, the top with the strip removed can thread onto the bottle's neck in place of the lid. As an option, a manual spout or a one-way flow valve on the top's stem can then allow the contents of the bottle to be drunk from the stem. The top can include two threads formed inside the top's rim. One thread can be formed in a narrow portion of the rim for threading on a narrow-neck bottle, while another thread can be formed on a wide portion of the rim, below the narrow portion, for threading on a wide-beck bottle.

The foregoing summary is not intended to summarize each potential embodiment or every aspect of the present disclosure.

### BRIEF DESCRIPTION OF THE DRAWINGS

FIG. 1 illustrates a bottle top according to the prior art attached to a beverage bottle.

FIGS. 2A-2C show perspective, cross-sectional, and elevational views of portion of the prior art bottle top.

FIG. 2D shows a top end of a beverage bottle with a foil seal attached to the upper rim according to the prior art.

FIGS. 3A-3E show perspective, elevational, cross-sectional, and two detailed views of a reusable bottle top according to the present disclosure disposed on a beverage bottle having an existing lid.

FIGS. 4A through 4G show the reusable bottle top in front, first elevational, cross-section, second elevational, perspective, bottom, and top views.

FIG. 5 is a cross-sectional detail of a portion of the reusable bottle top.

FIGS. 6A-6C shows further details of a catch mechanism on the reusable bottle top.

FIGS. 7A-7B show cross-sectional details of the reusable bottle top having alternative catch mechanisms.

FIGS. 8A-8D show assembly steps of the reusable bottle top on a beverage bottle having an existing lid.

FIG. 9A shows the reusable bottle top attached to the beverage bottle.

FIG. 9B shows the reusable bottle top removed from the bottle while the existing lid remains.

FIG. 9C shows the existing lid removed from the bottle.

FIG. 10 shows the reusable bottle top reattached to the open bottle.

FIGS. 11A-11B show cross-sectional and perspective views of a dual beverage bottle top according to the present disclosure.

FIG. 12A shows a cross-sectional view of the neck of a narrow-neck bottle for use with the dual bottle top.

FIG. 12B shows a cross-sectional view of the neck of a wide-neck bottle for use with the dual bottle top.

FIGS. 13A-13B show cross-sectional and elevational views of the dual bottle top disposed on the narrow-neck bottle.

FIGS. 14A-14B show cross-sectional and elevational views of the dual bottle top disposed on the wide-neck bottle.

FIGS. 15A-15B show cross-sectional views of two techniques for constructing the dual bottle top.

FIGS. 16A-16B show cross-sectional views of the dual bottle top disposed on the narrow-neck and wide-neck bottles using removable rims.

FIG. 17 shows a cross-sectional view of a reusable, dual bottle top according to the present disclosure.

FIGS. 18A-18B shows cross-sectional views of the reusable, dual bottle top attached in two ways to a narrow-neck bottle, which has an existing lid.

FIG. 19 shows a cross-sectional view of the reusable, dual bottle top attached to a wide-neck bottle, which has an existing lid.

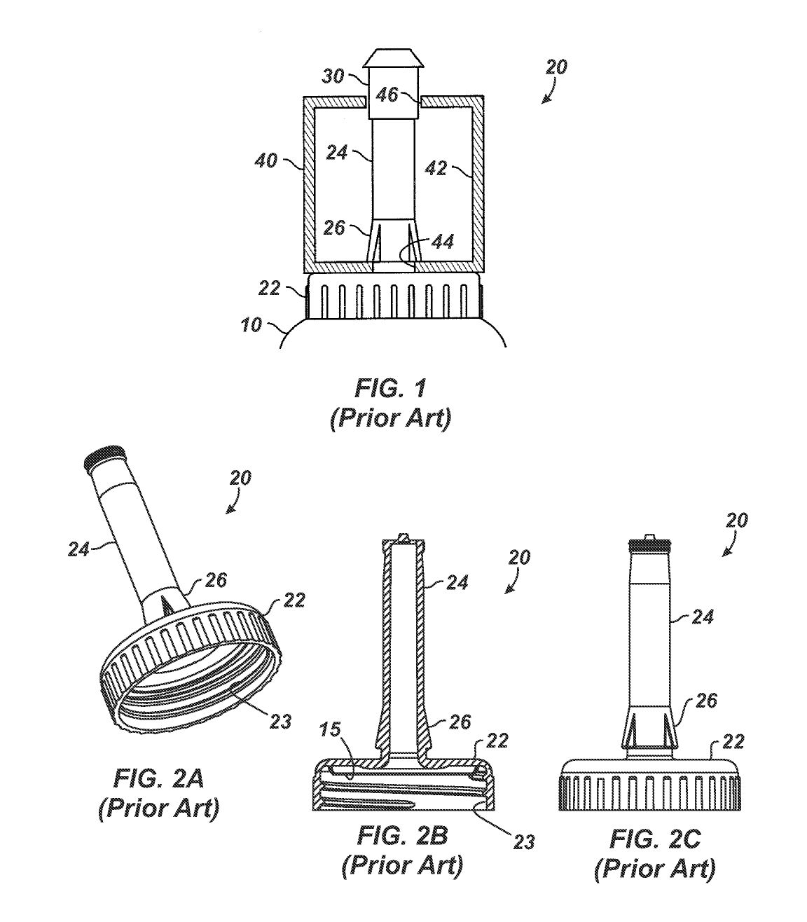

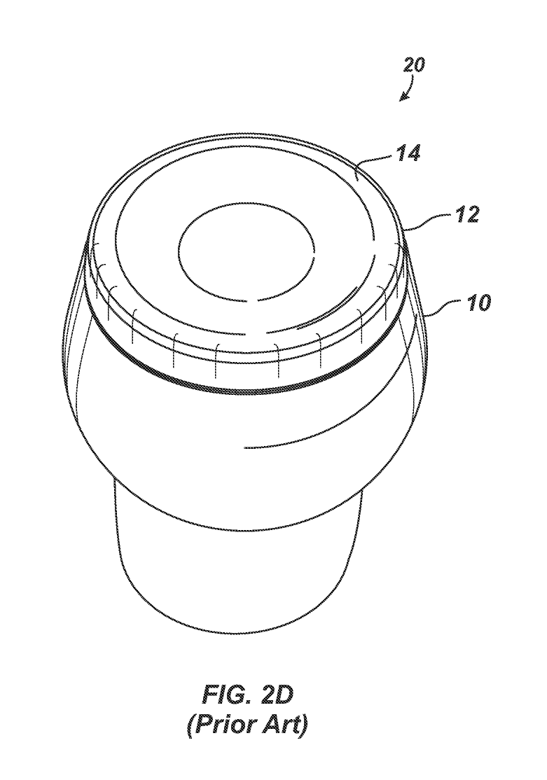

### DETAILED DESCRIPTION

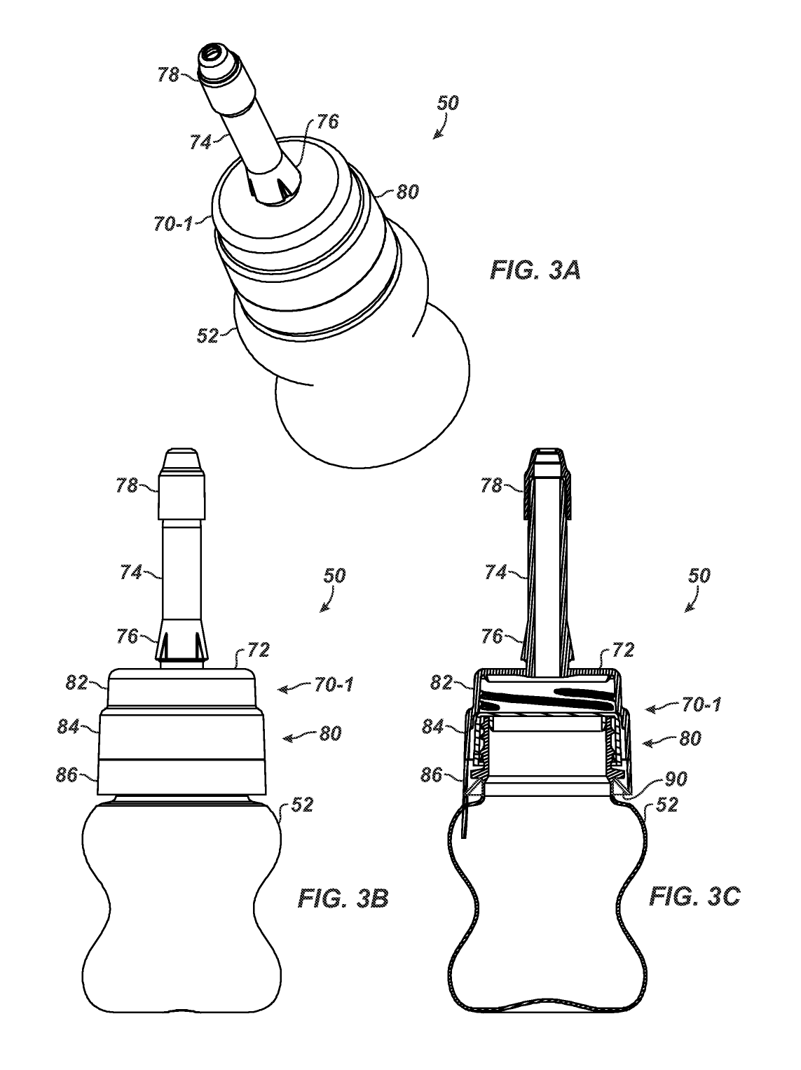

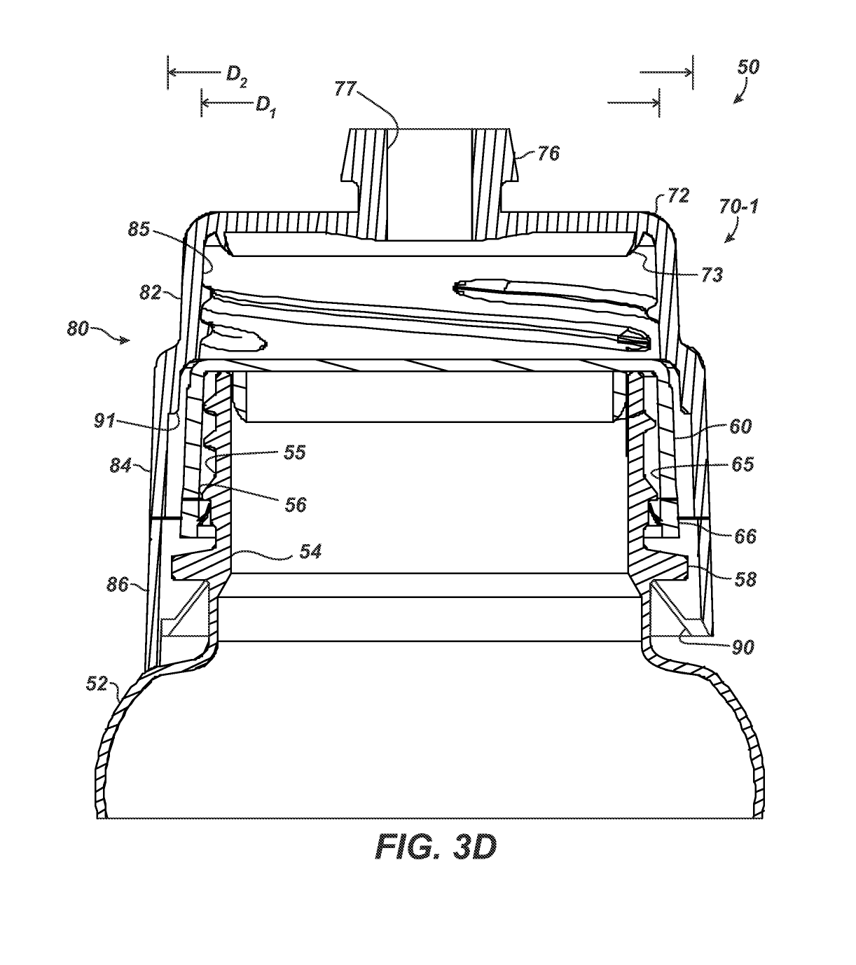

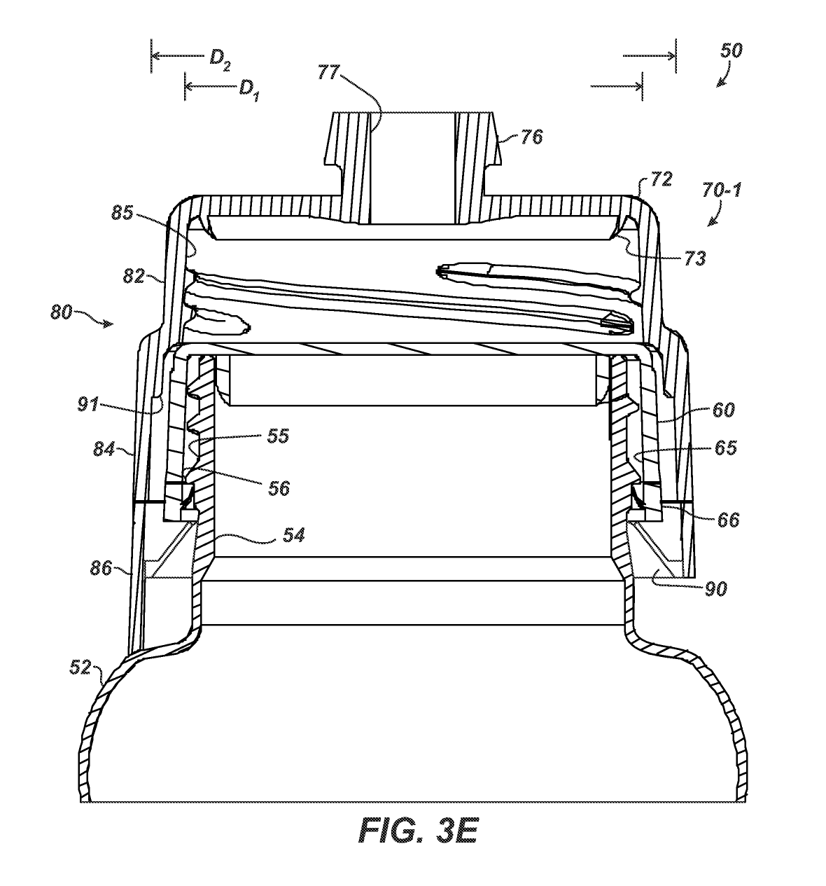

FIGS. 3A-3E show perspective, elevational, cross-sectional, and detailed views of a beverage container 50 according to the present disclosure. The container 50 has a bottle 52 having a neck 54 with an external thread 55 and a stop or ledge 56 (as best shown in FIGS. 3D-3E). The neck 54 is open to dispense liquid from the bottle 52. In FIG. 3D, the bottle 52 is formed with a circumferential ledge or stop 58 disposed thereabout, while the bottle 52 as depicted in FIG. 3E may lack this ledge or stop.

A lid 60 attaches to (i.e., threads onto) the bottle's threaded neck 54 in a customary manner. Rather than attaching a foil seal as in the prior art, the lid 60 threaded onto the neck 54 seals on the bottle 52 using internal threads 65 and a twist-off rim 66. As best shown in FIG. 3D, the twist-off rim 66 engages the bottle's stop 56 around the threaded neck 54. When the lid 60 is twisted off, however, this rim 66 tears away and stays in place as the lid 60 is removed from the bottle's neck 54 as described below.

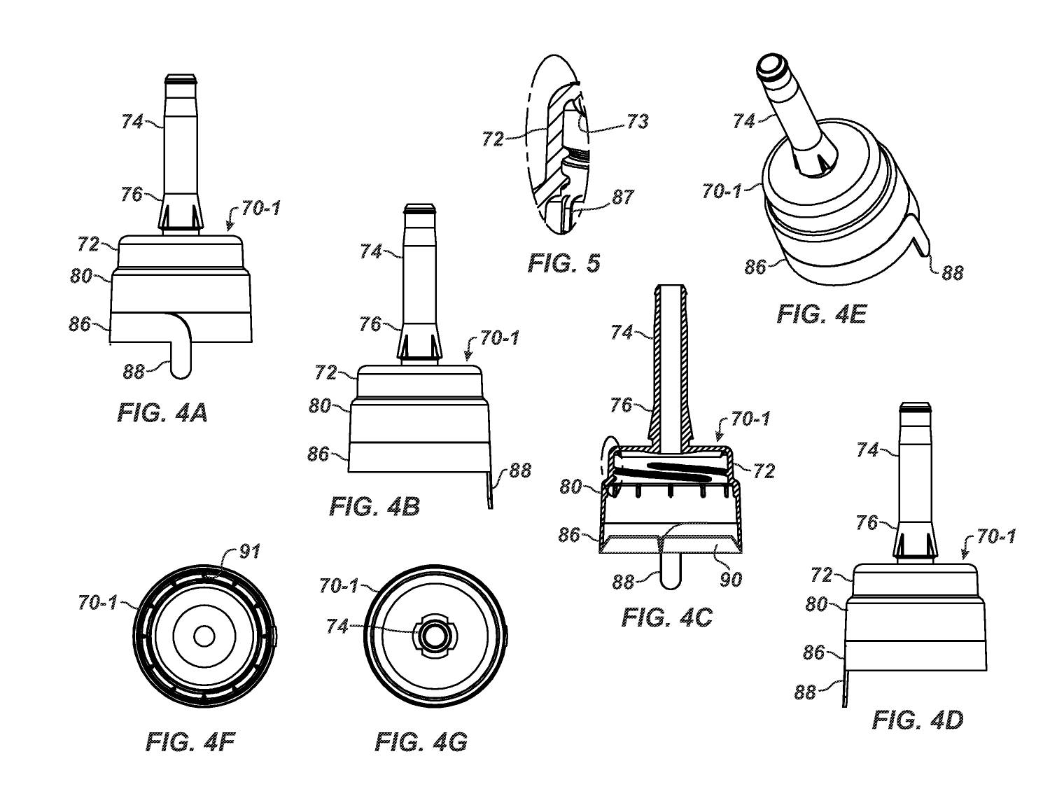

To give the container 50 its decorative features, a reusable bottle top 70-1 fits temporarily onto the lid 60 and the bottle 52 after they have been preassembled. (FIGS. 4A through 4G show front, first elevational, cross-section, second elevational, perspective, bottom, and top views of the reusable top 70-1, and FIG. 5 is a cross-sectional detail of a portion of the reusable top 70-1.) The reusable top 70-1 has two ways or modes of installing on the bottle 52. In a first mode for delivery, display, and sale of the container 50, the reusable top 70-1 installs on the bottle 52 while the lid 60 is still present on the bottle 52. In a second mode for use and drinking, the reusable top 70-1 installs on the bottle 52 with the lid 60 absent.

The reusable top 70-1 has a forecap 72 with a rim 80 depending downward therefrom. The forecap 72 defines a passage through which the bottle's beverage can be dispensed. The rim 80 has an upper portion or rim 82, which may also be referred to herein as a narrow portion or rim. Depending from this upper rim 82, the rim has a lower portion or rim 84, which may be referred to herein as a wide portion or rim. Inside the rim 80, the upper rim 82 has an internal thread 85 for threading to the threaded neck 54 of the bottle 52 in place of the lid 60 as discussed below.

Opposite the rim 80, a stem 74 extends from the forecap 72 for conveying liquid from the forecap's passage. The stem 72 can also hold a decorative body (not shown) on the forecap 72 using retainers 76 as discussed above. On its distal end, the stem 74 optionally has a movable spout or a one-way flow valve 78, as shown in FIGS. 3A-3C. The movable spout 78 can be manually opened and closed on the stem 74, whereas the one-way flow valve 78 uses a diaphragm or the like to permit fluid flow out of the stem 74.

To hold the top 70-1 on the assembled lid 60 and bottle 52, the lower rim 84 has a strip 86 removably affixed thereto. This removable strip 86 can tear away from the lower rim 84 using a handle 88 and a precut crease, perforations, or other feature that weakens the connection of the strip 86 to the lower rim 84 and allows a person to tear the strip 86 therefrom.

To engage the reusable top 70-1 on the bottle 52, this strip 86 has a catch mechanism 90 with one or more catches depending inward and preferably toward an upward direction. As discussed below, the catch mechanism 90 allows the reusable top 70-1 to install in a first direction onto the lid 60 during assembly. Then, the catch mechanism 90 engages the ledge 58 of the bottle 52 (as shown in FIG. 3D) or engages the lid 60 (as in FIG. 3E) to prevent removal of the top 70-1 in an opposite direction. In this way, the reusable top 70-1 installs temporarily on the assembled lid 60 and bottle 52.

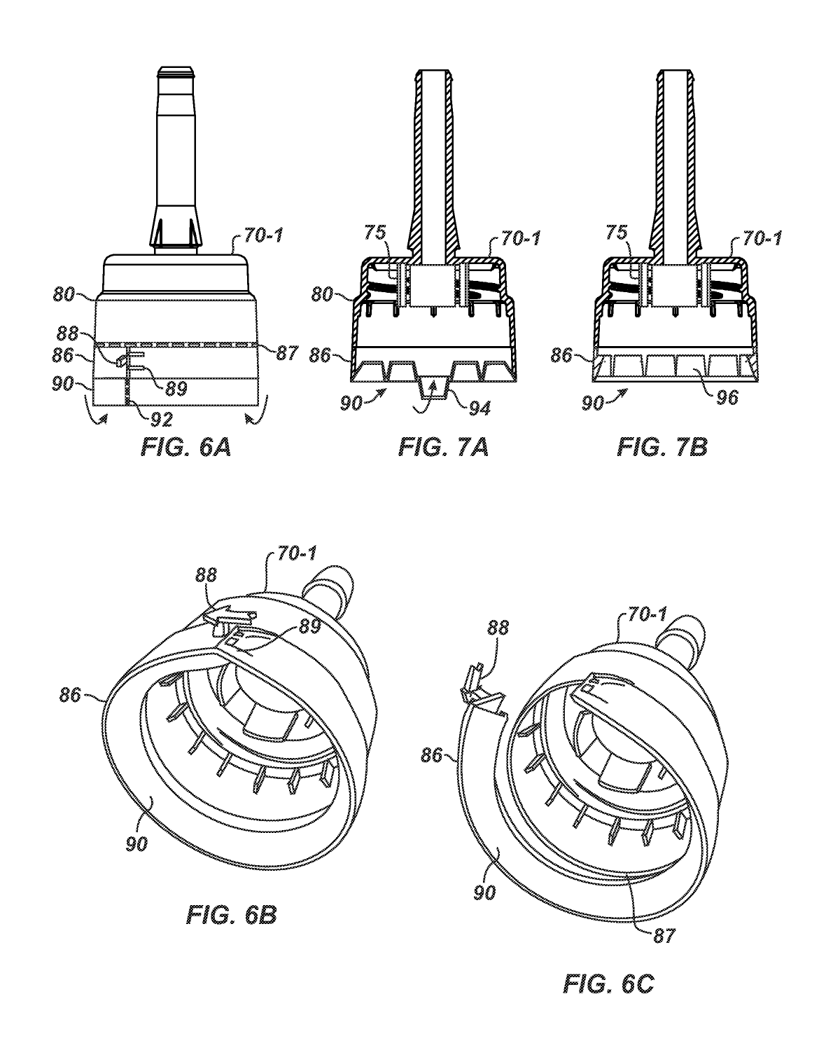

Several types of catch mechanisms 90 can be used on the removable strip 86 to hold the top 70-1 temporarily on the assembled lid 60 and bottle 52. As shown in FIGS. 3D-3E, for example, the catch mechanism 90 can include a fold with a proximal end attached inside the removable strip 86. In FIG. 3D, the distal end of the fold for the catch mechanism 90 can engage under the bottle's ledge 58 on the bottle 52. In FIG. 3E, however, the distal end of the fold for the catch mechanism 90 can engage under the rim 66 of the existing lid 60 as an alternative. More details of these arrangements are discussed below with reference to FIGS. 6A-6C, for example.

Other than a fold, the catch mechanism 90 can include a lip, ledge, shoulder, stop, or other engaging feature defined around the inside of the removable strip 86. When the reusable top 70-1 installs on the lid 60, the engaging feature can fit with an interference fit against the bottle's ledge 58 or the lid's rim 66. These and other options for the catch mechanism 90 can be used.

As best shown in FIG. 3D, the top's upper rim 82 having the internal thread 85 has a first internal diameter D₁ comparable to an outer diameter of the bottle's threaded neck 54 so the two can thread together when the reusable top 70-1 is used in place of the lid 60. However, the lower rim 84 has a second internal diameter D₂ greater than the first internal diameter D₁, which allows the reusable top 70-1 to fit partially on the lid 60 as shown. An inner transition from the first internal diameter D₁ to the second internal diameter D₂ can have a plurality of inward depending grips 91. As best shown on the reusable top 70-1 in FIG. 4F with the catch mechanism (90) not visible, these grips 91 can be disposed equally around the inside of the reusable top 70-1. One shape for such grips 91 can be seen in FIG. 5. In use, the grips 91 can help hold the top 70-1 in place and can prevent it from rotating when engaged with the lid 60. Also, the grips 91 and the transition on the reusable top 70-1 keep the top 70-1 at a stand-off on the lid 60, preventing the top 70-1 from be forced further onto the lid 60.

With the reusable top 70-1 affixed to the bottle 52 and lid 60 as shown in FIGS. 3C-3E, the assembly is less prone to tampering, theft, and damage. For example, removing the reusable top 70-1 requires a concerted effort because a person must remove the strip 86 on the rim 80 to take off the top 70-1 from the bottle 52. This inhibits tampering, theft, and damage.

Even if the reusable top 70-1 is removed, the remaining container 50 with its sealed lid 60 still protects the bottle's contents from tampering and damage. Should the removed top 70-1 be lost, stolen, or damaged, the remaining bottle 52 with lid 60 need not be discarded, and a replacement top 70-1 with an intact strip 86 can be readily attached to the bottle 52 according to the assembly steps disclosed herein. These unexpected benefits that lessen the tampering and theft of the assembled top 70-1 on the bottle 52 further add to the manufacturing benefits discussed below.

FIGS. 6A-6C shows additional details of the reusable top 70-1 and its assembly. As shown in FIG. 6A, the top 70-1 with its rim 80 can have a serrated seam 87 or similar feature temporarily connecting the removable strip 86 thereon. The tab 88 for the strip 86 can be a handle extending out from the strip 86 as opposed to downward extension shown above. As shown in FIGS. 6A-6B, the tab 88 fits at a split 92 in the strip 86 that allows the strip 86 to be removed, while interconnecting members 89 across this split 92 can connect the ends of the strip 86 together. As shown in FIG. 6C, the interconnecting members 89 are broken when the tab 88 is used to break the spilt 92 and remove the strip 86 from the rim 80 along the serrated seam 87.

As shown in FIG. 6A, the catch mechanism 90 can be an extension of the removable strip 86 and can have a thinner wall then the rest of the rim 80 and strip 86. As shown in FIGS. 6A-6B, the catch mechanism 90 folds inward into the reusable top 70-1 to form the angled fold around the inside of the top 70-1 as described above. It may also have interconnecting members 89 at the split 92 that break when the strip 86 is removed.

Although the catch mechanism 90 can be continuous around the circumference of the strip 86 as shown in FIGS. 6A-6C, alternative forms of catch mechanisms 90 can be used. For example, FIG. 7A shows a cross-sectional detail of the disclosed top 70-1 having an alternative catch mechanism 90A. Here, the catch mechanism 90A uses a number of extended tabs 94 from the strip 86 that fold inward into the reusable top 70-1. In FIG. 7B, the catch mechanism 90B on the inside surface of the strip 86 defines a shoulder, lip, stop, or ledge 96 molded thereon. The shoulder 96 can be segmented as shown or continuous around the inside of the strip 86. The shoulder 96 can also preferably define an angle that facilities fitting the shoulder over the lid (60) as described herein.

With the benefit of the present disclosure, it will be appreciated that other forms of catch mechanisms 90 could be used. The catch mechanism 90 is preferably flexible, either alone as in FIG. 6A or 7A or in conjunction with the strip 86 as in FIG. 7B. Either way, the catch mechanism 90 preferably allows the reusable top 70-1 to fit onto the lid (60) during assembly.

For additional stability, the reusable top 70-1 as shown in FIGS. 7A-7B can have mounts 75 extending downward inside the rim 80. When the top 70-1 is fit onto the bottle 52 and the lid 60, these mounts 75 can engage the lid 60, provide stability, and keep the top 70-1 at a stand-off from the lid 60. Moreover, when the top 70-1 is threaded directly onto the bottle's neck 54, the mounts 75 can help engage the top 70-1 thereon.

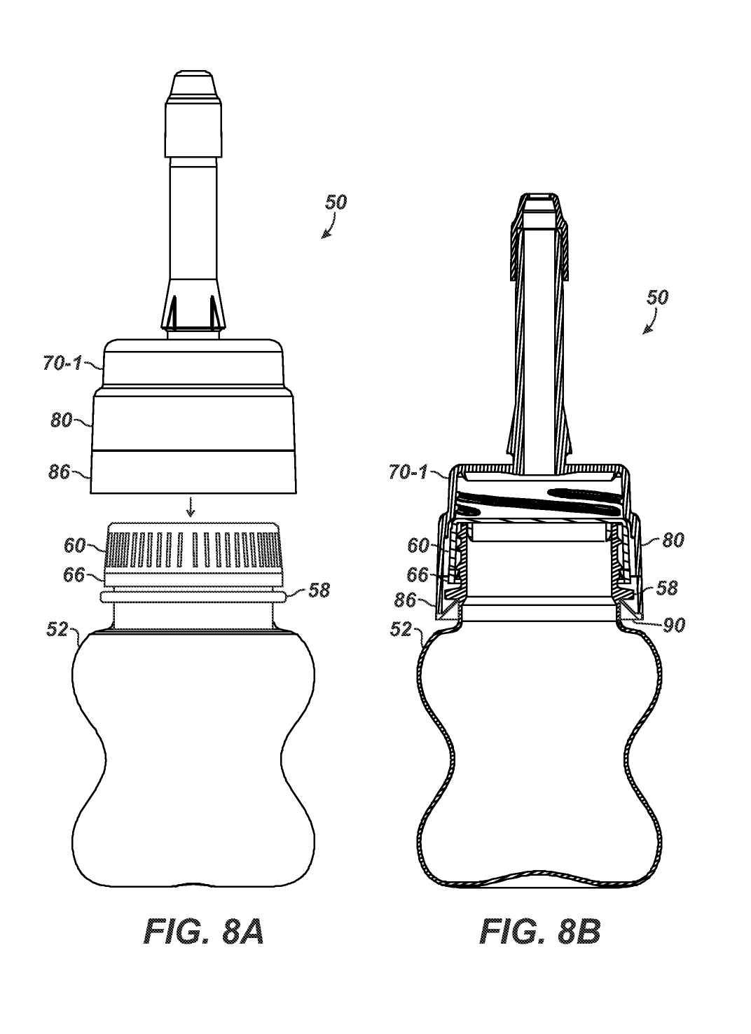

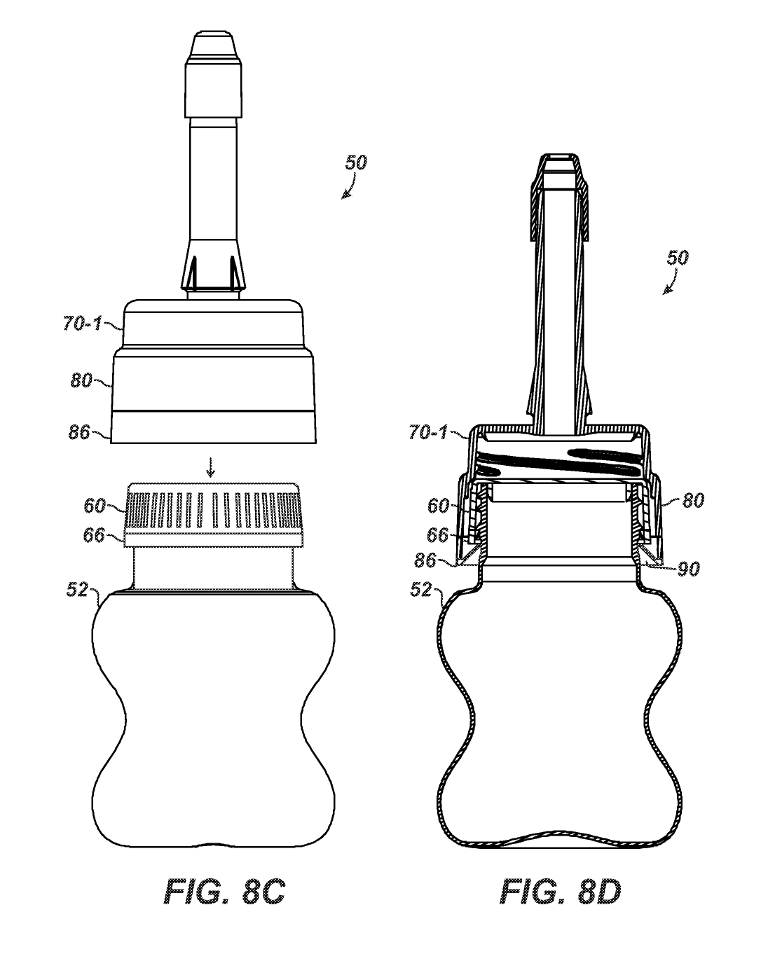

FIGS. 8A-8B show assembly steps of the reusable top 70-1 on the bottle 52 having the existing lid 60. The assembly is greatly simplified from the prior art where foil seals and manual or cumbersome assembly is required. Instead as shown in FIG. 8A, a lid 60 threads to the bottle 52 with the retaining rim 66 engaging the neck's stop (56; FIG. 3D). This can be done in a customary manner and can effectively seal the bottle 52.

The reusable top 70-1 then fits on the lid 60 assembled to the bottle 52 in a direct manner (e.g., pushing or snapping the top 70-1 on in one direction on the lid 60), rather than needing manual and/or cumbersome assembly steps. Being able to fit in one direction on the lid 60, the top 70-1 can be manually installed thereon, or this can be done in an automated fashion. When fitting the top 70-1 as shown in FIG. 8B, the catch mechanism 90 on the removable strip 86 first passes the lid 60 and then engages the underside of the bottle's ledge 58 disposed about the bottle's neck 54 (or engages the lid's rim 66 as noted below).

FIGS. 8C-8D show assembly steps of the reusable top 70-1 on the bottle 52 having the existing lid 60 when the bottle 52 lacks the ledge (58) discussed above. The same assembly steps are used. When fitting the top 70-1 as shown in FIG. 8D, however, the catch mechanism 90 on the removable strip 86 passes the lid 60 and then engages the underside of the lid's rim 66.

Once the reusable top 70-1 is pressed onto the lid 60 in either arrangement, the wider portion 84 of the rim 80 can accommodate the width of the existing lid 60, and the grips 91 can help hold the top 70-1 in place. The stand-off features (e.g., transition, grips 91, and mounts 75) can provide stability and keep the top 70-1 from being pushed further on the lid 60.

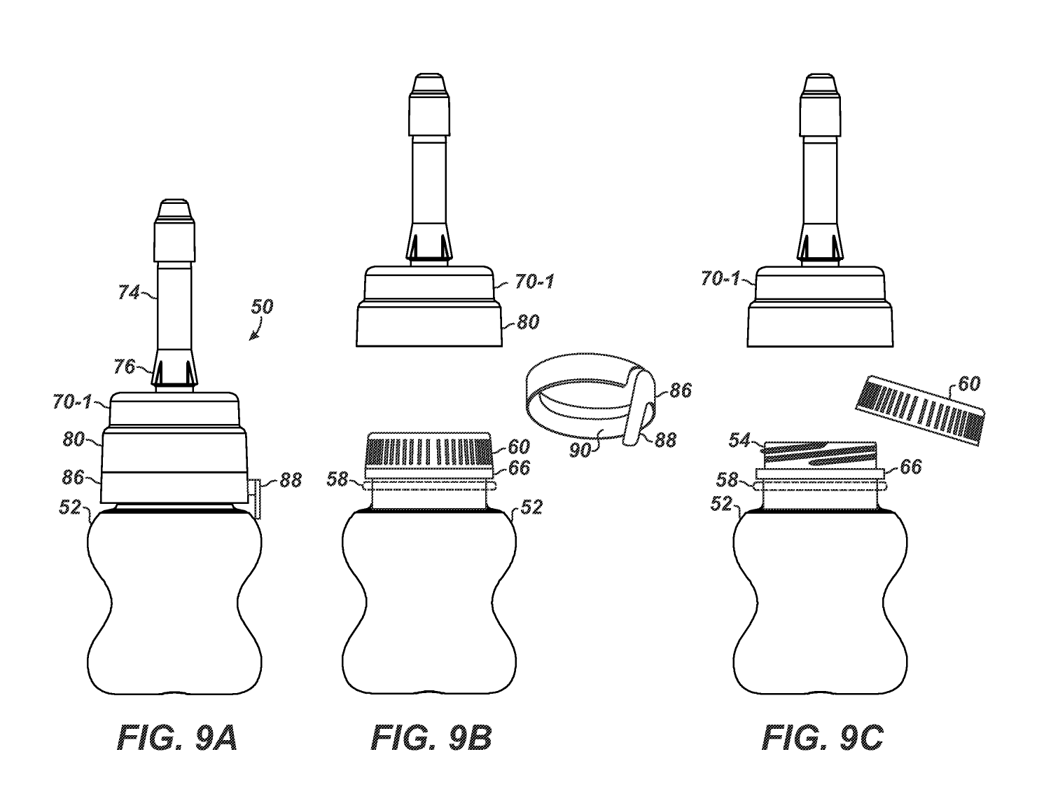

As shown in FIG. 9A, the spout or valve 78 can affix to the distal end of the stem 74, and the reusable top 70-1 can be outfitted with the decorative body (not shown) on the stem 74 and retainers 76. Depending on the desired assembly, either one or both of the spout 78 and the decorative body can assemble on the top 70-1 before or after installation of the top 70-1 on the bottle 52 and the lid 60.

At this point, the bottle 52, the lid 60, and the top 70-1 can be shipped, stored, displayed, and sold. To then drink the beverage in the bottle 52, the reusable top 70-1 is removed from the bottle 52 while the existing lid 60 remains on the neck 54 as shown in FIG. 9B. To do this, the removable strip 86 is pulled off the rim 80 of the top 70-1 by pulling the strip's tab 88 and tearing the strip 86 from the rim 80 via a seam, perforations, cuts, serrations, indentations, or the like. The top's grips (91) on the inside transition may prevent rotation of the top 70-1 on the existing lid 60 and help to hold the top 70-1 on the lid 60 temporarily until the strip 86 is pulled free.

When the strip 86 pulls free, the catch mechanism 90 on the strip 86 come free of the neck's ledge 58 or the lid's rim 66 depending on the arrangement. This allows the top 70-1 to be lifted off the existing lid 60. Now with the top 70-1 removed, the existing lid 60 can be removed from the bottle 52 as shown in FIG. 9C. As the lid 60 unthreads from the neck 54, the separable rim 66 breaks free and remains on the neck 54. The removed lid 60 exposes the neck 54 so the top 70-1 can then rethread onto the open bottle 52.

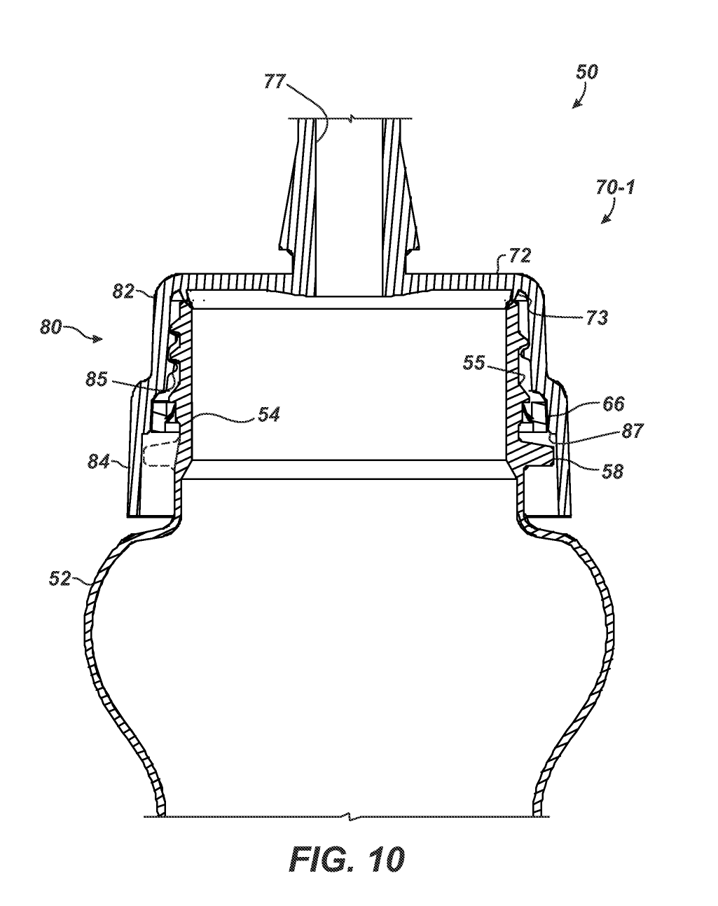

As shown by the reassembled bottle 52 and top 70-1 of FIG. 10, the top's internal thread 85 threads onto the neck's thread 55, and the crab seal 73 on the inside surface of the top's forecap 72 engages a distal edge of the bottle's neck 54. The seal 73 is intended to create a leak proof seal with the neck 54. The wider rim portion 84 fits around the bottle's ledge 58 (if present) and the remaining lid rim 66. The grips 91 can also press against the lid's rim 66 to hold and seal the top 70-1 in place. At this point, beverage from the bottle 52 can come out of the stem 74 to the spout or valve (not shown) through the stem's bore 77.

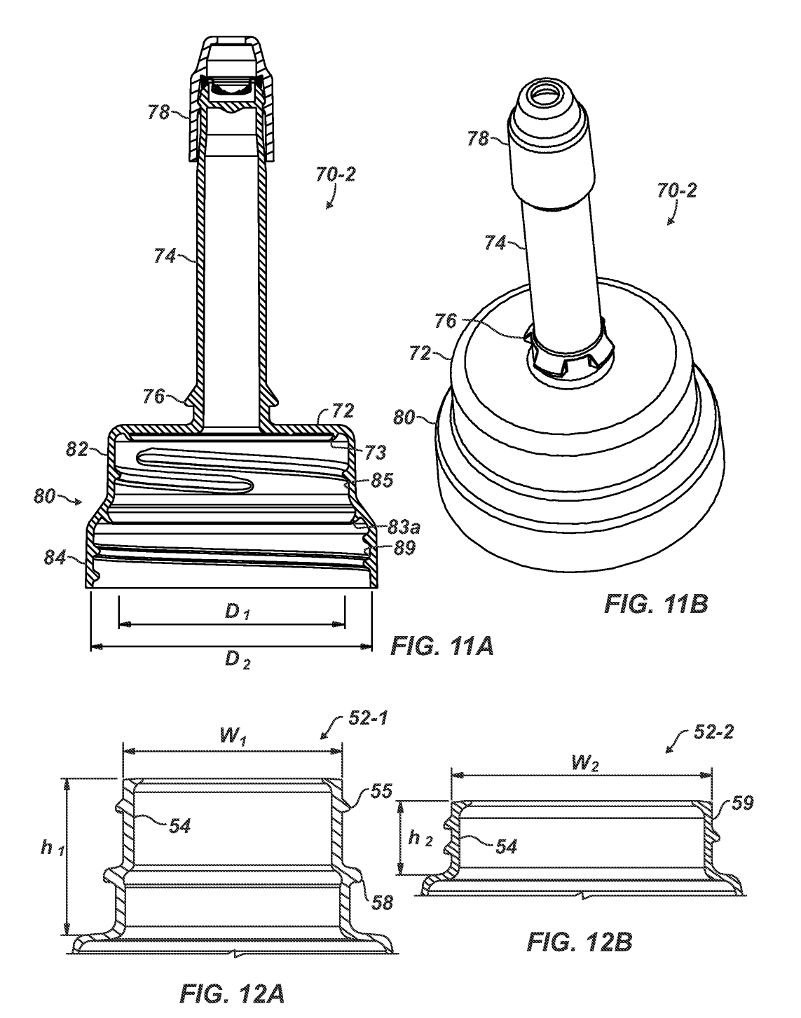

Turning now to FIGS. 11A-11B, another bottle top 70-2 according to the present disclosure can be used to attach to two types of beverage bottles of a container. This dual bottle top 70-2 includes many of the same features as in the above-embodiments so like reference numerals are used for similar components, which are not described again here. This dual bottle top 70-2 is also reusable, but includes a wide thread 89 in the wide portion 84 of the top's rim 80. Thus, the inner surface of the rim 80 includes narrow thread 85 at the narrow rim 82 and wide thread 89 at the wide rim 84. A crab seal 83a or other sealing element can be formed inside the rim 80 at the transition of these two rims 82 and 84 for engaging a bottle's neck as described below.

Having the two threads 85 and 89, the dual top 70-2 can be used on different sized bottles 52-1 and 52-2, which are shown in FIGS. 12A-12B. A narrow-neck bottle 52-1 of FIG. 12A has a neck 54 that is narrower than the neck 54 of the wide-neck bottle 52-2 of FIG. 12B. The narrow thread 85 inside the narrow portion 85 of the top's rim 80 is adapted to thread onto the thread 55 of the narrow-neck bottle 52-1, whereas the wide thread 89 inside the wide portion 85 of the top's rim 80 is adapted to thread on the thread 59 of the wide-neck bottle 52-2.

To provide example dimensions, the narrow-neck bottle 52-1 can have a neck 54 with a width W₁ of 38-mm wide and a height h1 of 25-mm tall, while the wide-neck bottle 52-2 can have a neck 54 with a width W₂ of 45-mm wide and a height h₂ of 12-mm tall. The top 70-2 has comparable inner diameters D₁ and D₂ for the rim portions 82 and 84 to thread on the bottles 52-1 and 52-2. Other dimensions can be used. The narrow-neck bottle 52-1 having the taller neck 54 may include an external ledge 58 as shown, while the wide-neck bottle 52-2 may not.

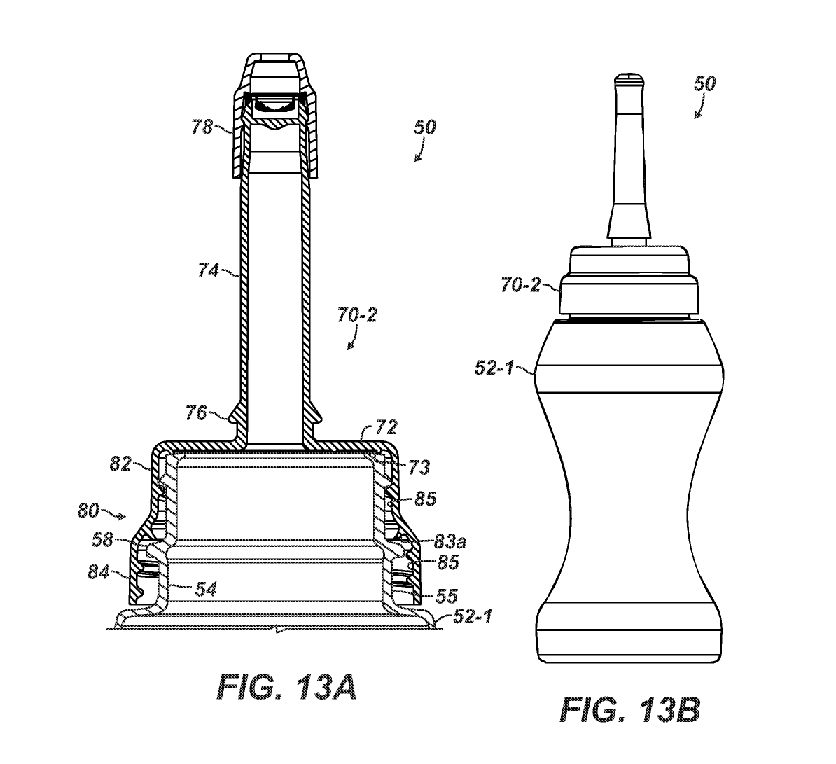

To help illustrate the dual use of the bottle top 70-2, FIGS. 13A-13B show the dual top 70-2 disposed on the narrow-neck bottle 52-1. The rim's wide portion 84 and its wide thread 89 can fit over the neck 54 of the narrow-neck bottle 52-1 and can avoid engaging the ledge 58 (if present). Meanwhile, the narrow thread 85 on the rim's narrow rim 82 can thread to the neck's thread 55. To help seal the top 70-2 on the bottle 52-1, the crab seal 73 on the inside of the forecap 72 can engage the distal rim of the neck 54.

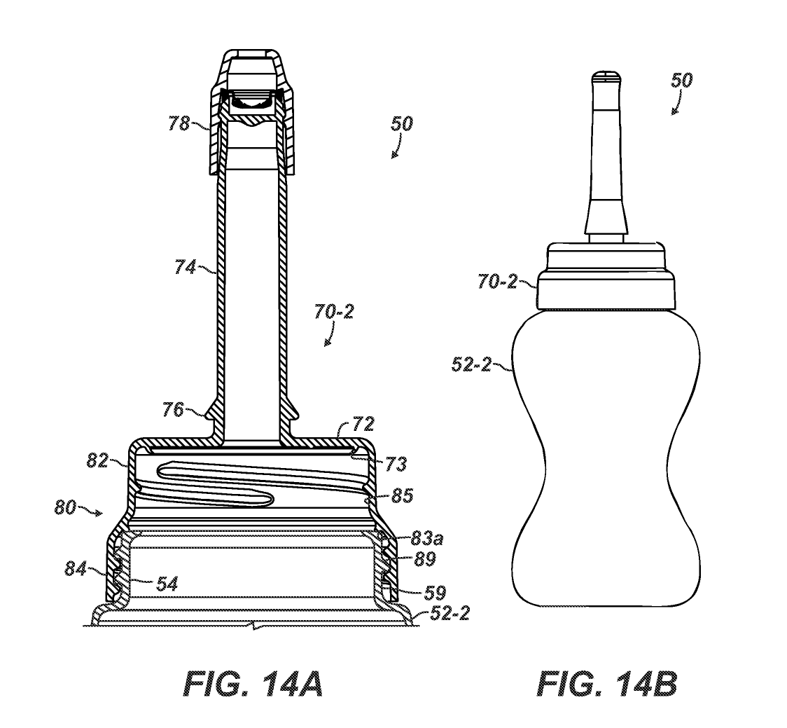

In a similar fashion, FIGS. 14A-14B show the dual bottle top 70-2 disposed on the wide-neck bottle 52-2. Here, the rim's wide portion 84 and its wide thread 89 thread onto the thread 59 on the wide-neck bottle 52-2. Meanwhile, the narrow thread 85 on the top's narrow rim 82 stands off from the neck 54. To help seal the top 70-2 on this bottle 52-2, a crab seal 83a at the transition of the rim 80 can engage the distal rim of the neck 54.

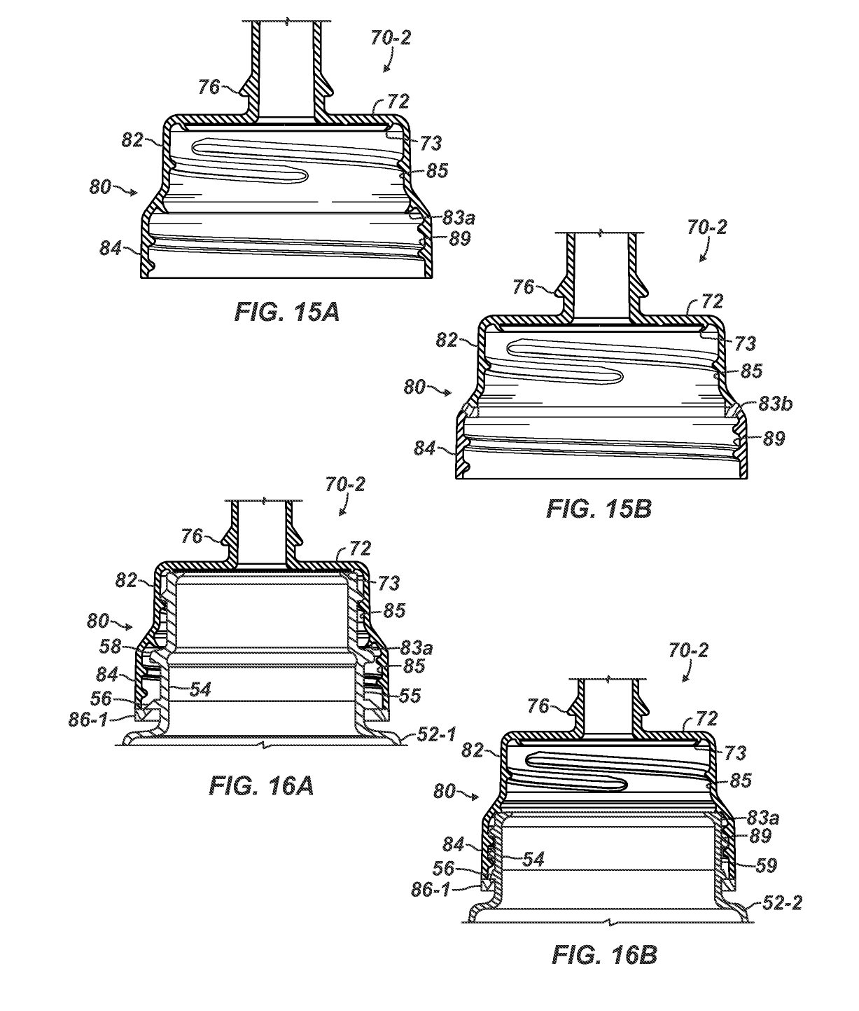

The dual purpose top 70-2 disclosed above can be constructed in a number of ways. For example, FIG. 15A shows the top 70-2 constructed using a mono-injection molding process of Polypropolene (PP). This top 70-2 has the crab seals 73 and 83a formed integrally inside the top 70-2. Alternatively, FIG. 15B shows the dual bottle top 70-2 constructed using a bi-injection molding process. The forecap 72, the upper rim 82, and the lower rim 84 are constructed of Polypropolene (PP), while an intermediate component 83b is composed of a Thermoplastic Elastomiser (TPE). This intermediate component 83b can act as a seal for engaging the wide-neck bottle's neck 54.

The dual bottle top 70-2 disclosed above can initially be disposed on a bottle to which it is affixed for commercial sale. As shown in FIG. 16A, for example, the top 70-2 can be sold disposed on a narrow-neck bottle 52-1 disclosed above. As shown, the lower rim 84 has a removable strip 86-1 (e.g., twist-off rim), which can be similar to the twist-off rim 66 of FIGS. 3D-3E and 8A-8D. This twist-off rim or removable strip 86-1 can be used to seal the top 70-2 on the bottle 52-1 and can engage an appropriate stop 56 (e.g., similar to the stop 56 of FIGS. 3D-3E) on the bottle 52-1 for engaging the twist-off rim or strip 86-1. By twisting the top 70-2, a person can remove the top 70-2 from the bottle 52-1 so that the twist-off rim or strip 86-1 is broken and left on the bottle 52-1. A foil seal (if present) on the bottle 52-1 can then be removed, and the top 70-2 can be reattached to the same bottle 52-1 for use in drinking a beverage. Later, the top 70-2 can be removed for cleaning. At this point, the top 70-2 can be used on the same bottle 52-1 to which it was originally attached, or it can be used with a different bottle (e.g., wide-neck bottle) having a different sized neck for which the top 70-2 is adapted to install on. This makes the dual bottle top 70-2 particularly useful with a number of different bottles.

In a similar fashion, FIG. 16B shows how the top 70-2 can be sold disposed on a wide-neck bottle 52-2 disclosed above. Again, the lower rim 84 has a removable strip 86-1 (e.g., twist-off rim), which can be similar to the twist-off rim 66 of FIGS. 3D-3E and which can be used to seal the top 70-2 on the bottle 52-2. Likewise, the bottle 52-2 can have an appropriate stop 56 (e.g., similar to the stop 56 of FIGS. 3D-3E) for engaging a catch of the twist-off rim 86-1.

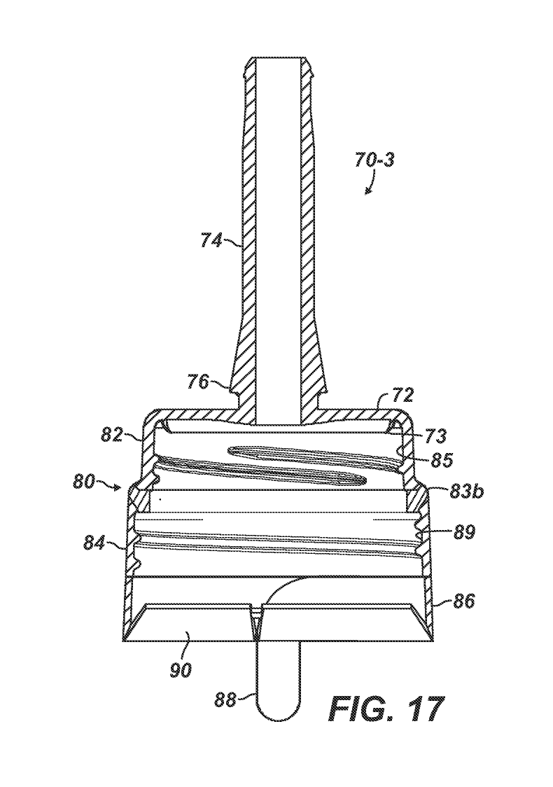

The above dual bottle top 70-2 can also include a form of temporary retention such as disclosed above with reference to the reusable tops 70-1 of FIGS. 3A through 10 so that the top 70-2 can be disposed and held on an existing lid of a bottle. To that end, FIG. 17 shows a beverage bottle top 70-3, which is reusable and can be used on multiple bottles according to the present disclosure. This top 70-3 includes similar features to those discussed above so that like reference numerals are used for similar components, which are not readdressed in detail here. The top 70-3 includes a strip 86 removably affixed to the rim's lower portion 84. As detailed above, this strip 86 can tear away from the rim portion 84 using a handle 88 and a precut crease, perforations, or other feature that weakens the connection of the strip 86 to the rim portion 84 and allows a person to tear the strip 86 therefrom.

To engage the top 70-3 on a bottle, this strip 86 has a catch mechanism 90, which allows the top 70-3 to install in a first direction onto an existing lid and which temporarily holds the top 70-2 on the bottle. Any of the various catch mechanisms 90 disclosed herein can be used for this top 70-3. Finally, the top 70-3 also includes the narrow thread 85 and the wide thread 89 discussed above on the inside of the rim 80 so the top 70-3 can be used on bottles having different sized necks.

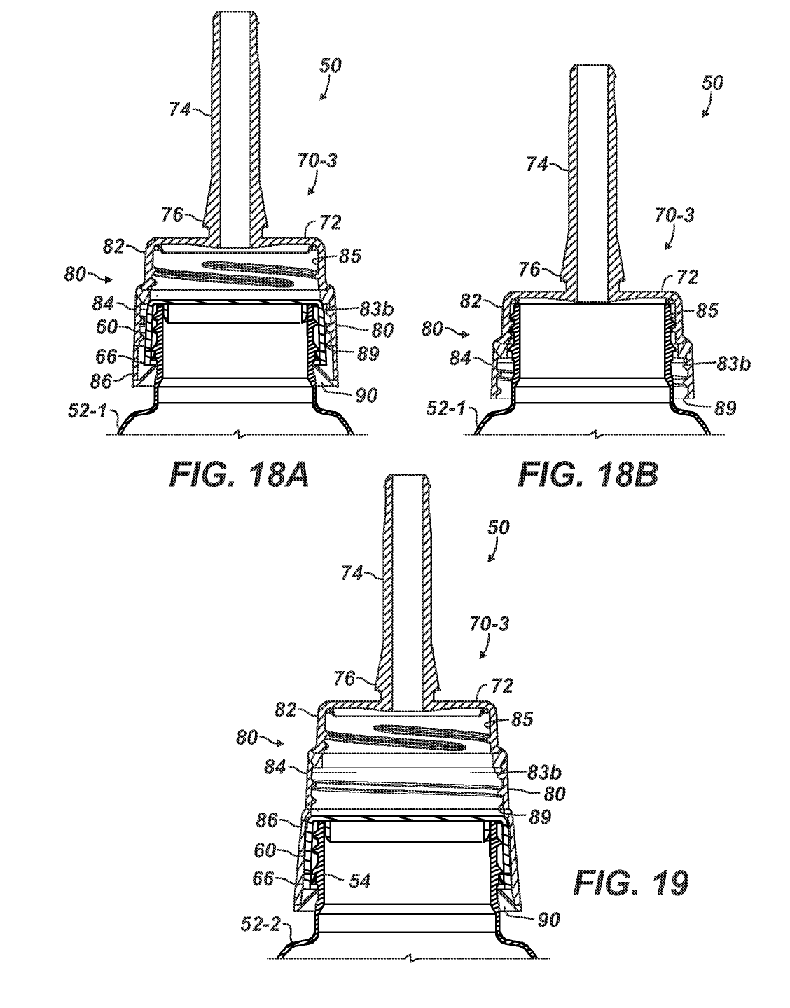

Use of this top 70-3 is similar to the other tops disclosed herein. As shown in FIGS. 18A-18B, for example, the top 70-1 can fit onto an existing lid 60 threaded onto a bottle, which in this case is a narrow-neck bottle 52-1. The catch mechanism 90 on the top's removable strip 86 engages the underside of the lid's rim (as shown) or the bottle's ledge (58) depending on the arrangement. Because the bottle 52-1 has a narrow neck 54, the wide portion 84 of the rim 80 accommodates the width of the existing lid 60, and the seal 83a or grip 83b can help hold the top 70-3 in place, providing a stand-off and preventing the top 70-3 from being rotated.

To use the top 70-3 for drinking, the removable strip 86 is pulled off the rim 80 so that the catch mechanism 90 releases the top 70-3 from the existing lid 60. Now with the top 70-3 removed, the existing lid 60 can be removed from the bottle 52-1, and the top 70-3 can then reattach to the open bottle 52-1 by threading the narrow thread 85 to the neck's thread 55. As noted above, this top 70-3 can be removed and cleaned and can then be reused on the same narrow-neck bottle 52-1 or on a wide-neck bottle 52-1 as disclosed above, due to its two internal threads 85 and 89.

As shown in FIG. 19, the bottle top 70-3 can be initially used on a wide-neck bottle 52-2 having an existing lid 60. In this case, the rim 80 stands off from the existing lid 60. Likewise, the removable strip 86 extends the height of the lid 60 and accommodates the lid's width so that the catch 90 can engage the rim 66 of the lid 60 (as shown) or a ledge or other portion of the bottle 52-2. As will be appreciated with the benefit of the present disclosure, modifications to the height and width of the various components may be needed.

It will be appreciated with the benefit of the present disclosure that features described above in accordance with any embodiment or aspect of the disclosed subject matter can be utilized, either alone or in combination, with any other described feature, in any other embodiment or aspect of the disclosed subject matter. As will also be appreciated, various components of the disclosed bottle tops can be composed of a suitable plastic material and can be formed by traditional molding techniques known in the art so that these are not detailed herein.

Although disclosed for use with a container and bottles for drinking a beverage, the disclosed bottle tops can be used for other types of containers from which a liquid is to be dispensed.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A top for a bottle, the bottle having a neck and having a lid threaded on the neck, the top comprising:
a cap defining a passage for dispensing liquid from the bottle;
a rim depending from the cap, the rim having an internal thread adapted to thread onto the neck of the bottle in place of the lid; and
a strip removably affixed to the rim, the strip holding the cap on the lid and being removable from the rim to release the cap from the lid.

2. The top of claim 1, wherein the strip comprises:
a catch disposed on the strip, the catch inserting onto the lid in one direction and engaging a portion of the bottle or the lid to prevent removal of the cap from the lid in an opposite direction.

3. The top of claim 2, wherein the catch engages a ledge disposed on the neck or engages an edge on the lid.

4. The top of claim 2, wherein the catch comprises a fold having a proximal end and a distal end, the proximal end flexibly attached to the removable strip, the distal end engageable with the portion of the bottle or the lid.

5. The top of claim 1, wherein the rim comprises an upper rim portion having the internal thread and having a first internal dimension comparable to an outer dimension of the neck; and wherein the rim comprises a lower rim portion having a second internal dimension greater than the first internal dimension.

6. The top of claim 5, wherein the rim comprises an inner transition disposed at the first and second internal dimensions and having a plurality of inward depending grips.

7. The top of claim 5, wherein the lower rim portion comprises another internal thread adapted to thread onto a neck of another bottle.

8. The top of claim 7, wherein the rim comprises a seal disposed at an inner transition of the first and second internal dimensions and adapted to engage the neck of the other bottle when the cap threads thereon.

9. The top of claim 1, wherein the cap comprises a seal disposed on an inside surface and adapted to engage the neck of the bottle when the cap threads on the neck in place of the lid.

10. The top of claim 1, further comprising a stem extending from the cap and communicating with the passage for dispensing the liquid.

11. The top of claim 10, wherein the stem comprises a spout or valve disposed thereon for controlling the dispensing of the liquid.

12. The top of claim 10, further comprising a decorative body disposed on the stem.

13. The top of claim 1, wherein:
the cap has first and second modes of installing on the bottle;
in the first mode, the cap installs on the bottle with the lid present such that the strip holds the cap on the bottle; and
in the second mode, the cap installs on the bottle with the lid absent and with the strip removed such that the internal thread holds the cap to the neck of the bottle.

14. The top of claim 13, wherein the cap comprises means for standing off the lid when installed in the first mode on the bottle.

15. A container, comprising:
a bottle having a neck;
a lid threading onto the neck;
a cap having a rim depending therefrom, the rim having an internal thread adapted to thread onto the neck of the bottle in place of the lid; and
a strip removably affixed to the rim, the strip holding the cap on the lid and being removable from the rim to release the cap from the lid.

16. The container of claim 15, wherein the bottle comprises a ledge disposed on the neck, and wherein the removable strip engages the ledge and prevents removal of the cap from the lid.

17. The container of claim 15, wherein the strip engages an edge of the lid and prevents removal of the cap from the lid.

18. The container of claim 15, wherein the rim comprises an upper rim portion having the internal thread and having a first internal dimension comparable to an outer dimension of the neck; and wherein the rim comprises a lower rim portion having a second internal dimension greater than the first internal dimension.

19. The container of claim 18, wherein the lower rim portion comprises another internal thread adapted to thread onto a neck of another bottle.

20. A container, comprising:
a bottle having a first neck and having a lid threaded on the first neck; and
a cap comprising:
means for dispensing liquid from the bottle when the lid is absent,
means for holding the cap onto the lid while the lid is threaded on the first neck, and
means for threading the cap onto the first neck in place of the lid.

21. The container of claim 20, wherein the means for holding the cap onto the lid comprises means for engaging a portion of the lid or a portion of the bottle.

22. The container of claim 20, wherein the means for holding the cap onto the lid comprises means for removing from the cap from the lid while the lid is threaded on the neck.

23. The container of claim 20, wherein the cap further comprises means for threading the cap onto a second neck of another bottle, the second neck having a different width than the first neck.

24. The container of claim 20, wherein the cap further comprises means for holding a decorative body.

25. The container of claim 20, wherein the cap further comprises means for standing the cap off the lid when the cap is held onto the lid.

26. The container of claim 20, wherein the cap further comprises means for preventing rotation of the cap while the cap is held onto the lid.

27. A top, comprising:
a cap defining a passage for dispensing liquid;
a first rim depending from the cap, the first rim having a first internal dimension and a first internal thread, the first internal thread adapted to thread onto a neck of a first bottle; and
a second rim depending from the first rim, the second rim having a second internal dimension and a second internal thread, the second internal dimension being greater than the first internal dimension, the second internal thread adapted to thread onto a neck of a second bottle.

28. The top of claim 27, wherein the top installs onto a lid threaded on the neck of the first bottle, the top further comprising:
a strip removably affixed to the second rim, the strip holding the cap on the lid and being removable from the second rim to release the cap from the lid.

29. The top of claim 28, wherein the strip comprises:
a catch disposed on the strip, the catch inserting onto the lid in one direction and engaging a portion of the first bottle or the lid to prevent removal of the cap from the lid in an opposite direction.

30. A container, comprising:
a first bottle having a first neck;
a lid threaded on the first neck;
a cap defining a passage for dispensing liquid from the bottle; and
a rim depending from the cap, the rim having:
a first portion having a first internal dimension and a first internal thread, and
a second portion depending from the first portion, the second rim having a second internal dimension and a second internal thread, the second internal dimension being greater than the first internal dimension;
wherein one of the first and second internal threads is adapted to thread onto the first neck of the first bottle in place of the lid, and
wherein the other of the first and second internal threads is adapted to thread onto a second neck of a second bottle.

31. The container of claim 30, wherein the cap fits onto the lid while the lid is threaded on the first neck of the first bottle, the cap further comprising:
a strip removably affixed to the rim, the strip holding the cap on the lid and being removable from the rim to release the cap from the lid.

32. The container of claim 31, wherein the strip comprises:
a catch disposed on the strip, the catch installing onto the lid in one direction and engaging a portion of the bottle or the lid to prevent removal of the cap from the lid in an opposite direction.

33. A beverage system, comprising:
a first bottle having a first neck with a first width;
a second bottle having a second neck with a second width, the second width being different from the first width; and
a cap comprising:
means for dispensing liquid from the first and second bottles,
means for threading the cap onto the first neck of the first bottle, and
means for threading the cap onto the second neck of the second bottle.

34. The system of claim 33, wherein the first bottle comprises a lid threaded on the first neck, and wherein the cap comprises means for holding the cap onto the lid while the lid is threaded on the first neck.

35. A beverage container assembly method, comprising:
threading a lid on a neck of a bottle;
installing a cap on the lid;
passing a catch on a removable strip of the cap past the lid when installing the cap on the lid; and
holding the cap on the lid and the bottle by engaging the catch of the removable strip on a portion of the bottle or the lid.

36. The method of claim 35, further comprising attaching a decorative body onto a stem of the cap.

37. The method of claim 35, further comprising attaching a spout or valve on the stem of the cap.

38. The method of claim 35, further comprising prior to fitting the cap on the lid:
forming the cap with the catch as a circumferential extension of the removable strip of the cap; and
folding the circumferential extension inward into the cap around the removable strip.

39. The method of claim 35, wherein passing the catch past the lid and engaging the catch comprises permitting the catch to flex outward from the lid and subsequently flex inward under the portion of the bottle or the lid.

40. The method of claim 35, wherein installing the cap on the lid comprises standing an internal thread of the cap above the lid.
